(19) United States
(12) Patent Application Publication
(10) Pub. No.: US 2006/0120474 A1
(43) Pub. Date: Jun. 8, 2006

(54) Mapping method for signal combining in a wireless communication system

(75) Inventors: Sung-Kwon Hong, Seoul (KR); Jin-Kyu Koo, Suwon-si (KR); Dong-Seek Park, Yongin-si (KR); Young-Kwon Cho, Suwon-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/295,085

(22) Filed: Dec. 6, 2005

(30) Foreign Application Priority Data
Dec. 6, 2004 (KR) 102045/2004

(51) Int. Cl. H04L 5/12

(52) U.S. Cl. 375/261

(57) ABSTRACT

In a mapping method for signal combining in a wireless communication system, it is determined whether a full search is possible for an arbitrary mapping table. If the full search is possible, search metric values are computed for all possible constellation combinations and a constellation with a minimum value is produced using the computed search metric values. If the full search is not possible, a search metric value within an irregular constellation is continuously reduced, the reduced search metric value corresponding to a minimum value is obtained and a constellation with a minimum value is produced using the obtained reduced search metric value.

### PRIORITY

This application claims priority under 35 U.S.C. § 119 to an application entitled “Mapping Method for Signal Combining in a Wireless Communication System” filed in the Korean Intellectual Property Office on Dec. 6, 2004 and assigned Serial No. 2004-102045, the contents of which are incorporated herein by reference.

### BACKGROUND OF THE INVENTION

1. Field of the Invention

The present invention generally relates to a wireless communication system requiring signal combining, and more particularly to a search metric for signal combining in a digital communication system requiring combining of a plurality of signals and an optimal mapping method using the search metric.

2. Description of the Related Art

In general, fourth-generation (4G) mobile communication systems corresponding to next-generation mobile communication systems require a high-speed and high-capacity communication system capable of processing and providing various information such as video and wireless data as well as voice-centric services. To meet this need, a suitable channel-coding scheme can improve system throughput and performance in the 4G mobile communication systems.

However, such factors as multi-path interference, shadowing, propagation attenuation, time variant noise and fading can cause error and information loss in wireless channel environments of mobile communication systems, which differs from wired channel environments. The information loss can severely distort an actually transmitted signal and degrade the overall performance of the mobile communication system.

Accordingly, communication systems increase system reliability using various error control techniques based on channel characteristics to reduce information loss. In these error control techniques, the most basic method is the use of an error correcting code.

The communication system corrects an error due to noise occurring in a transmission channel. In a conventional error correction scheme, information bits are transmitted from a transmitting side to a receiving side through a codeword coded in a coding scheme. Then, the receiving side receives the codeword from the transmitting side. Through a decoding scheme associated with the coding scheme applied in the transmitting side, the receiving side decodes the received codeword to recover original information bits.

A design for a constellation mapping method for use in the communication system has been developed through research on an optimal mapping method for bit interleaved and coded modulation (BICM) among coding schemes in which iterative decoding is possible. The constellation mapping method has been designed for use with the BICM. Alternatively, the constellation mapping method may be commonly applied to other coding schemes in which the iterative decoding is possible. Moreover, the constellation mapping method may be applied to schemes other than the coding schemes in which the iterative decoding is possible. Now, a conventional coding scheme based on the BICM will be described with reference to FIG. 1

FIG. 1 is a schematic block diagram illustrating a structure of transmitting/receiving stages using a conventional coding scheme.

Referring to FIG. 1, a transmitting side includes an encoder 101, an interleaver 103, a mapper 105, and a receiving side includes a demapper 107, a deinterleaver 109, and a decoder 111.

First, the operation of the transmitting side will be described.

The encoder 101 processes and encodes given input information bits in a block unit. The interleaver 103 interleaves the bits encoded by the encoder 101 and outputs the interleaved bits to the mapper 105. The mapper 105 converts the interleaved bits to a baseband signal and then outputs the baseband signal. A radio frequency (RF) processor (not illustrated) converts the signal output from the mapper 105 to an RF signal and then transmits the RF signal through a channel. At this time, the signal transmitted through the channel is subject to additive white Gaussian Noise (AWGN) due to fading or thermal noise in mobile environments.

Next, the operation of the receiving side will be described. The demapper 107 demaps a baseband signal transmitted to the receiving side through the channel according to a demapping scheme associated with the signal mapping scheme applied in the transmitting side, and outputs the baseband signal to the deinterleaver 109. The deinterleaver 109 receives and deinterleaves the demapped signal and then outputs the deinterleaved signal to the decoder 111. The decoder 111 receives the signal output from the deinterleaver 109 and then decodes the received signal according to a decoding scheme associated with the coding scheme applied in the transmitting side. At this time, the signal output from the decoder 111 undergoes a soft decision process. A result of the soft decision process, i.e., a soft decision value, is extracted, such that a decoded value is finally generated.

In the above-described communication system, the constellation mapping significantly affects the BICM performance. Accordingly, a large amount of research has been recently conducted on the constellation mapping. For example, a mapping method has been developed by Frank Schreckenbach. The mapping method of Frank Schreckenbach generates arbitrary mapping tables, compares the generated mapping tables through a predetermined performance evaluation criterion and searches and selects an optimal table according to the criterion. In this case, a full search is possible in modulation schemes such as Quadrature Phase Shift Keying (QPSK) and 8-Phase Shift Keying (8PSK) in which the number of signal points is relatively small. However, the full search is impossible in modulation schemes such as 16-Quadrature Amplitude Modulation (16QAM) in which the number of signal points is relatively large because a full search range is very wide. For example, the full search cannot take place in the 16QAM because the full search range in the 16QAM is 16!.

An optimal mapping table is selected using a binary switching algorithm for reducing a search metric value of a randomly generated initial mapping table to a minimum value. This binary switching algorithm is repeatedly performed many times such that the optimal mapping table can be selected. This binary switching algorithm does not search for a minimum value in the total range through a full search, but has an advantage in that a locally optimal mapping table can be configured.

The search metric value has a form in which an error event probability of a concatenated code, i.e., a bit unit, is minimized. Here, the error event probability is a probability in which a codeword is erroneously decoded due to channel noise and distortion. The error probability of a bit unit is proportional to the error event probability. The search metric in each channel environment will be described.

Assuming that a channel is a fading channel, the search metric can be expressed as Equation (1).

$${D}^{r} = \frac{1}{{q2}^{q}} {\sum }_{i = 1}^{q} {\sum }_{b = 0}^{1} {\sum }_{{S}_{k} ∈ {X}_{b}^{i}}^{} {\sum }_{{\hat{S}}_{k} ∈ X \frac{i}{b}}^{} \frac{1}{{\vert {S}_{k} - {\hat{S}}_{k} \vert}^{2}} \qquad Equation ( 1 )$$

In Equation (1), D^{r} denotes the search metric when the channel is the fading channel, and q denotes the number of bits according to a modulation scheme. For example, the parameters q of QPSK and 8PSK are 2 and 3, respectively. The parameter b is binary and X_{b}ⁱ denotes a signal set with the parameter b in the i-th bit position. The parameter \overline{b} denotes the complement of the parameter b. That is, the parameter \overline{b} is 1 if the parameter b is 0, and the parameter \overline{b} is 0 if the parameter b is 1. Sₖ denotes one of signal points belonging to the set X_{b}ⁱ and Ŝₖ denotes one of signal points belonging to the set X_{\overline{b}}ⁱ. The search metric value is computed using a sum of all signal points belonging to the sets.

Assuming that a channel is an AWGN channel, the search metric can be expressed as Equation (2).

$${D}^{a} = \frac{1}{{q2}^{q}} {\sum }_{i = 1}^{q} {\sum }_{b = 0}^{1} {\sum }_{{S}_{k} ∈ {X}_{b}^{i}}^{} {\sum }_{{\hat{S}}_{k} ∈ X \frac{i}{b}}^{} exp ( - \frac{{E}_{s}}{4 {N}_{0}} {\vert {S}_{k} - {\hat{S}}_{k} \vert}^{2} ) \qquad Equation ( 2 )$$

In Equation (2), D^{a} denotes the search metric when the channel is the AWGN channel, and q denotes the number of bits according to a modulation scheme. For example, the parameters q of QPSK and 8PSK are 2 and 3, respectively. The parameter b is binary and X_{b}ⁱ denotes a signal set with the parameter b in the i-th bit position. The parameter \overline{b} denotes the complement of the parameter b. That is, the parameter \overline{b} is 1 if the parameter b is 0, and the parameter \overline{b} is 0 if the parameter b is 1. Sₖ denotes a signal point belonging to the set X_{b}ⁱ and Ŝₖ denotes a signal point belonging to the set X_{\overline{b}}ⁱ. Eₛ denotes the energy per symbol of a signal and Nₒ denotes an AWGN density.

When the channel is the AWGN channel, an energy-to-noise

$$( \frac{{E}_{s}}{{N}_{0}} )$$

ratio is required to compute the search metric value as shown in Equation (2). Preferably, the energy-to-noise ratio is set on the basis of a target energy-to-noise ratio of a system to be implemented. The energy-to-noise ratio indicates an average error probability of a bit unit when the search metric value is considered

On the basis of prior information to be transferred, the following two cases can be considered in relation to Equations (1) and (2). Here, the prior information is internally transferred according to the number of iterations in an iterative decoding process and indicates a coefficient for improving decoding performance.

In the first case, the prior information is completely transferred. That is, information about remaining bits other than a bit of a position in which a bit metric is computed is known when signal points are decoded in the iterative decoding process. In this case, the iterative decoding process is performed according to a large number of iterations, and the number of signal points corresponding to the signal set X_{\overline{b}}ⁱ is one. When the number of iterations increases, the prior information to be transferred in the decoding process is set under an assumption that remaining bit values, designating constellation points, other than the parameter b are completely transferred.

In the second case, no prior information is available. That is, an iterative decoding process is not considered and a decoding operation is performed without prior information. This corresponds to the first decoding operation of the iterative decoding process. In this case, the number of signal points corresponding to the signal set X_{\overline{b}}ⁱ is 2^{m-1}.

Consequently, when the prior information is present, information about bits other than a bit of a position in which a metric is currently computed is provided. The number of signal points of a signal set to be computed is set to “2”. On the other hand, since information about bits other than a bit currently being computed is absent when prior information is absent, all possible bit values are considered and 2^{m-1} signal points are considered to compute a metric value.

Both of the iterative and non-iterative decoding operations are possible in the BICM scheme. The non-iterative decoding operation is the first decoding operation of the iterative decoding process. A constellation design for the iterative decoding differs from that for the non-iterative decoding even when parts other than a constellation mapping part are identical.

FIG. 2 schematically illustrates a constellation design method using a conventional 8PSK modulation scheme.

First, an example in which D^{r} shown in Equation (1) is computed when the 8PSK modulation scheme is adopted in the BICM will be described with reference to FIG. 2. When the prior information is absent, the first bit is b=1. When the prior information is present, the first bit is b=0.

The case where the prior information is absent will now be described. When the number of signal points with b=1 is four, the reciprocals of the squared Euclidean distances are computed with respect to, for example, “100”, “110”, “101”, and “111” as illustrated in FIG. 2. The search metric D^{r} is obtained by computing a sum of the reciprocals.

The case where the prior information is present will now be described. When the prior information is, for example, “00”, the reciprocal of the squared Euclidean distance is computed with respect to a signal point of “100” and then the search metric D^{r} is computed. In other words, the prior information is iteratively computed through the iterative decoding process. Accordingly, a soft decision value rather than a hard decision value of “00” is transferred.

The above-described search metric is an induced result under an assumption that a signal-to-noise ratio (SNR) is high.

However, performance values may not be arranged in order of search metrics when the SNR is relatively low. For example, the performance values of the search metrics may be inversely arranged. A need exists for a mapping method with the improved performance even when the SNR is relatively low.

To implement the mapping method in the case of the low SNR, the number of error event occurrences as well as performance metrics shown in the above equations needs to be optimized. When the search metric is introduced on the basis of a primary search criterion and an identical metric value is provided, a mapping method which minimizes the average number of errors in a bit or symbol unit is selected, such that the performance at a relatively low SNR can be optimized. In terms of the number of errors, the secondary search metric can be expressed as Equation (3).

$${N}_{min} ( 1 ) = \frac{1}{{q2}^{q}} {\sum }_{i = 1}^{q} {\sum }_{b = 0}^{1} {\sum }_{{S}_{k} ∈ {X}_{b}^{i}}^{} {N}_{min} ( 1 , {S}_{k} ) \qquad Equation ( 3 )$$

In Equation (3), Nₘᵢₙ denotes the minimum number of neighbor signal points in which an error may occur in a symbol unit. q denotes the number of bits according to a modulation scheme. For example, the parameters q of QPSK and 8PSK are 2 and 3, respectively. The parameter b denotes a binary bit and X_{b}ⁱ denotes a signal set with the parameter b in the i-th bit position. Sₖ denotes one of signal points belonging to the set X_{b}ⁱ. Nₘᵢₙ(1,Sₖ) denotes the number of signal points within X_{\overline{b}}ⁱ having the minimum Euclidean distance dₘᵢₙ from Sₖ. That is, Nₘᵢₙ(1,Sₖ) denotes the average number of neighbor signal points in which an error may occur in a bit unit. For example, Nₘᵢₙ(1,Sₖ) becomes “2” when the first bit in 8PSK is “0”, four signal points of “000”, “010”, “100” and “110” are considered, and a Gray mapping method is used.

Next, another search metric associated with the number of errors can be expressed as Equation (4).

$${N}_{b} = {\sum }_{i = 0}^{{2}^{q} - 1} p ( i ) {\sum }_{j = 1}^{{N}_{i}} {n}_{b} ( i , j ) \qquad Equation ( 4 )$$

In Equation (4), p(i) denotes a probability of selection of an arbitrary i signal point. q denotes the number of bits according to a modulation scheme. Nᵢ denotes the number of neighbor signal points having the minimum Euclidean distance in which the i signal point may have an error. n_{b}(i,j) denotes the number of error bits when the i signal point is erroneously determined to be the j signal point. N_{b} denotes the number of neighbor signal points in which an error may occur in a symbol unit.

The conventional channel code, the conventional modulation scheme, and the convention search metric structure have been described above.

Digital communication systems in which various signals are combined have recently been developed. For example, such systems include a Hybrid Automatic Retransmission eQuest (HARQ) communication system, a communication system using a relay and a macro diversity system; An optimal mapping method is needed for a communication system using a decoding process through signal combining. Specifically, a need exists for an optimal mapping method capable of extending the conventional search metric and a method capable of improving the performance and throughput of the digital communication system through the optimal mapping method.

### SUMMARY OF THE INVENTION

It is, therefore, an object of the present invention to provide a search metric that can extend a conventional search metric and can be applied to a system requiring combining of multiple signals, and an optimal mapping method for signal combining using the search metric.

It is another object of the present invention to provide an optimal mapping method that can improve performance through signal combining when a channel coding scheme in which different modulation schemes are mutually combined is considered in a plurality of communication systems.

It is yet another object of the present invention to provide a search method that can improve higher link level performance and system throughput in a wireless communication system, and an optimal mapping method using the search method.

The above and other objects of the present invention can be achieved by a mapping method for signal combining in a wireless communication system, including the steps of determining whether a full search is possible for an arbitrary mapping table, computing search metric values for all possible constellation combinations when the full search is possible and producing a constellation with a minimum value using the computed search metric values, and continuously reducing a search metric value within an irregular constellation when the full search is not possible, obtaining the reduced search metric value corresponding to a minimum value and producing a constellation with a minimum value using the obtained reduced search metric value.

The above and other objects of the present invention can also be achieved by a mapping method using a search metric in a digital communication system requiring signal combining, including the steps of computing a first search metric value at a high signal-to-noise ratio (SNR) and a second search metric value at a low SNR when a full search is possible for an arbitrary mapping table, updating a constellation using minimum values of the computed first and second search metric values, generating a random constellation when a number of searches for an irregular constellation does not exceed a maximum value when the full search is not possible for the arbitrary mapping table, computing first and second search metric values for the generated random constellation through a binary switching algorithm and updating a constellation using minimum values of the computed first and second search metric values.

### BRIEF DESCRIPTION OF THE DRAWINGS

The above and other objects and advantages of the present invention will be more clearly understood from the following detailed description taken in conjunction with the accompanying drawings, in which:

FIG. 1 is a schematic block diagram illustrating a structure of transmitting/receiving stages using a conventional coding scheme;

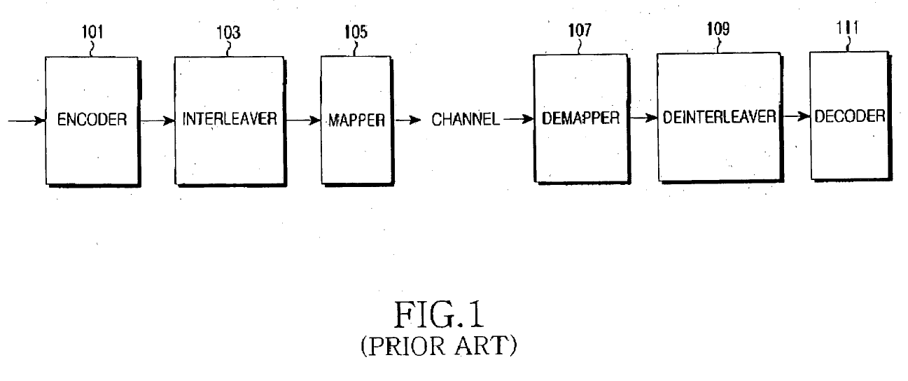

FIG. 2 illustrates a constellation design method using a conventional modulation scheme;

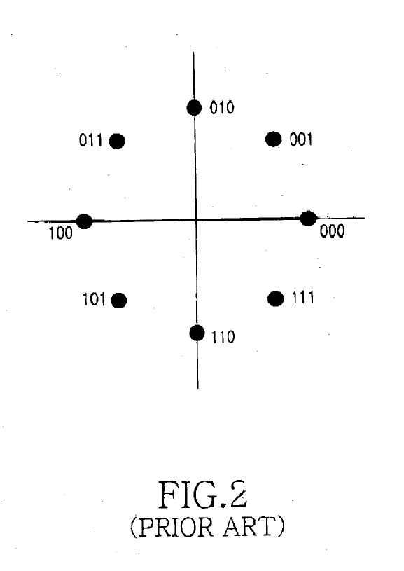

FIG. 3 is a schematic block diagram illustrating a conventional hybrid automatic retransmission request (HARQ) scheme;

FIG. 4 is a schematic block diagram illustrating a wireless communication system requiring signal combining in accordance with an embodiment of the present invention; and

FIG. 5 is a flowchart illustrating a search process using a search metric in accordance with an embodiment of the present invention.

### DETAILED DESCRIPTION OF THE PREFERRED EMBODIMENTS

Preferred embodiments of the present invention will be described in detail herein below with reference to the accompanying drawings. In the following description, detailed descriptions of functions and configurations incorporated herein that are well known to those skilled in the art are omitted for sake of clarity and conciseness.

The present invention proposes a mapping method that can improve link level performance and system throughout in a communication system requiring signal combining such as a Hybrid Automatic Retransmission reQuest (HARQ) communication system, a communication system using a relay and a macro diversity communication system.

An embodiment of the present invention proposes a constellation mapping method in a digital communication system that requires signal combining. Also, The embodiment of the present invention proposes a form in which channel coding, interleaving and bandwidth efficient modulation schemes for processing in a bit unit are combined.

The channel coding to be processed in the bit unit means that an input and output of a channel encoder and internal processing are performed in the bit unit. This channel coding process can use a variety of codes such as a convolutional code, a turbo code and a low density parity check (LDPC) code, but cannot use a trellis coded modulation (TCM) scheme.

The bandwidth efficient modulation schemes have the bandwidth efficiency of greater than 1. The bandwidth efficient modulation schemes include a Quadrature Phase Shift Keying (QPSK), 8-Phase Shift Keying (8PSK) and Quadrature Amplitude Modulation (QAM). When the bandwidth efficient modulation communication system is combined with channel coding, it can be broadly interpreted as a Bit Interleaved Coded Modulation (BICM) communication system.

When the iterative decoding process is possible, the interleaving operation is conventionally performed between channel decoding and modulation for the performance improvement of the iterative decoding process.

As described above, there are various digital communication systems requiring signal combining. Examples of an HARQ communication system, a communication system using a relay and a macro diversity communication system will now be described.

HARO Communication System

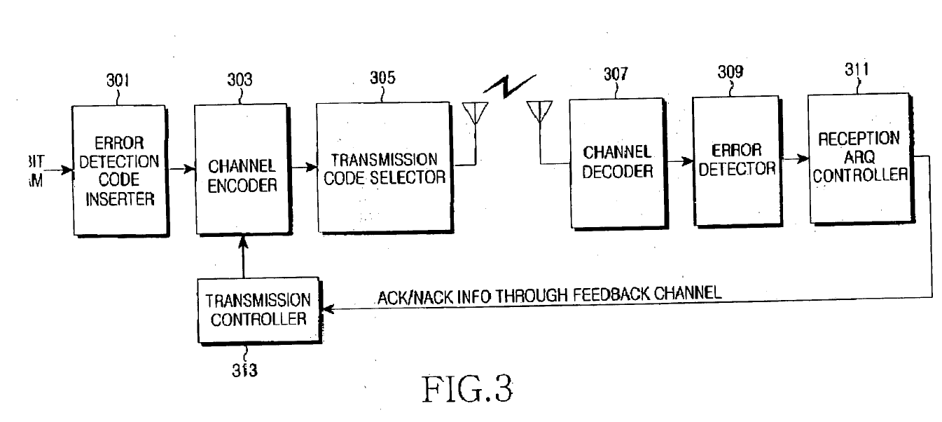

The HARQ scheme is a scheme in which an automatic retransmission request (ARQ) scheme and an error correcting code scheme are combined. Now, the HARQ scheme will be described with reference to FIG. 3.

FIG. 3 is a schematic block diagram illustrating the conventional HARQ scheme.

Referring to FIG. 3, a transmitting side includes an error detection code inserter 301, a channel encoder 303, a transmission code selector 305 and a transmission controller 313, and a receiving side includes a channel decoder 307, an error detector 309 and a reception ARQ controller 311.

The receiving side checks an error of a frame received through a communication channel according to the HARQ scheme. When the error occurs, the receiving side notifies the transmitting side of the error through a feedback channel. Upon receiving the notification, the transmitting side retransmits a frame associated with the error to the receiving side, thereby increasing robustness to an error of the communication channel. The error correcting code is transmitted as side information (SI) added to an original information frame. The receiving side corrects a channel error using the received frame.

When the HARQ scheme is combined with the error correcting code, various combining schemes can be provided. Three of those schemes will now be described in detail.

In a first scheme, the transmitting side retransmits a frame identical to an original frame when the receiving side determines that an error has occurred through the frame coded with an error correcting code. The receiving side independently decodes the retransmitted frame.

In a second scheme, the transmitting side retransmits a frame identical to an original frame when the receiving side determines that an error has occurred through the frame coded with an error correcting code. The receiving side performs a decoding process using the previously received frame and the retransmitted frame. At this time, the previously received frame and the currently received frame corresponding to the retransmitted frame are soft-combined by chase combining (CC). Here, the previously received frame and the currently received frame are equal in transmission times of the transmitting side. However, the receiving side receives the frames with different values due to distortion and noise occurring in a channel when the frames pass through the channel. Accordingly, the receiving side performs a decoding process on the basis of an arithmetic average computed between the previously and currently received frames. This decoding process is known as chase combining.

In a third scheme, the transmitting side retransmits a frame different from the previously transmitted frame when the receiving side determines that an error has occurred through the frame coded with an error correcting code. Here, the different frame has a different coding scheme. That is, a frame coded in the different coding scheme for identical information bits is retransmitted. At this time, the retransmitted frame is code-combined with the previously received frame. This code combining outperforms chase combining.

The third scheme is subdivided into two categories. In the first category, the receiving side can independently decode the retransmitted frame. Since this scheme not only can generate a gain through the code combining but also can perform the decoding operation using the retransmitted frame, it can handle various situations occurring in a communication channel.

In the second category, the receiving side cannot independently decode the retransmitted frame. Since this scheme only retransmits a frame including only SI less than the total information frame, the retransmitted frame different from that of other schemes is provided in a small unit. Accordingly, the independent decoding process for the retransmitted frame is not possible in the receiving side. This scheme is referred to as the incremental redundancy (IR) scheme. The IR scheme generally exhibits excellent performance in terms of throughput.

Among the three schemes, the second and third schemes perform signal combining in the HARQ scheme. Since an arithmetic addition operation is performed between signals through chase combining, the second scheme does not require an optimized design. The third scheme requires an optimized design in signal combining.

Communication System Using Relay

Conventionally, a relay is placed between a mobile station (MS) and a base station (BS). When normal communication is not possible due to a deteriorated channel situation between the MS and the BS or communication quality needs to be improved, the relay relays a signal from the MS to the BS or from the BS to the MS.

For example, the relay can amplify a signal transmitted from the MS and send the amplified signal to the BS. Alternatively, the relay can decode the signal transmitted from the MS, recode the decoded signal and send the coded signal to the BS. Relays can be classified into a fixed relay and a mobile relay according to mobility.

The fixed relay has a position similar to the BS. The fixed relay links the BS to neighbor MSs. Because the fixed relay can be designed in a stable position according to a plan, it may have a relatively large physical size as compared with the mobile relay. The fixed relay can provide a good channel state to the MSs. For example, multiple antennas with a relatively long length can be installed at a relatively high position and available power can increase. The fixed relay enables wired communications between the BSs.

The mobile relay can perform a relay function while it is in motion like the MS. Substantially, the MS located within a cell can perform the relay function in a cellular system. When the MS is used as a mobile relay, a probability in which the line of sight different from that of the fixed relay exists is high and a relatively poor channel environment may be provided while the MS is in motion. A drawback to the MS is that performance improvement through multiple antennas is difficult.

The following scenarios can be considered when a signal is transferred between the MS and the BS using the above-described relay.

A first scenario wherein the MS delivers a signal to the relay and the relay delivers the signal to the BS can be considered. When multiple relays exist, each relay serves as a transmitter with at least one antenna. Through this, various performance improvement techniques can be introduced into a multi-input multi-output (MIMO) system. A MIMO communication method can be applied through transmissions of the MS at different times even when the number of relays is one. In this case, it can be assumed that the relay is located between the MS and the BS and various link combinations between the MS and the BS exist.

A second scenario wherein the relay communicates with the BS in a state in which it has the same condition as an MS, such as the where another MS serves as the mobile relay, can be considered. The MS and the relay exchange data to be transmitted through cooperation and identical MSs jointly transmit data. In this case, code combining technologies can be used. The MIMO technologies can be applied for transmission to the BS. Also in the second scenario, it can be assumed that various link combinations different from a link between the MS and the relay exist. The relay and, the MS can both communicate with the BS.

Because the BS receives signals from many entities in the above-described first and second scenarios, signal combining is required to improve system performance. Accordingly, an optimized design for signal combining is also required in the relay communication system.

Macro Diversity Communication System

In the macro diversity communication system, the MS communicates with multiple BSs rather than one BS. The BSs send different optimized signals rather than identical signals, such that the system can improve link performance in terms of the MS.

In the communication system that requires signal combining, the signal combining is considered to combat channel distortion and noise and improve communication performance. A channel coding scheme is important in the system based on the signal combining. The channel coding scheme exists in various forms, and codes for which iterative decoding is possible are of interest since they exhibit excellent performance when a size of a block to be processed is large.

The codes for which the iterative decoding is possible include turbo codes, serially concatenated codes and LDPC codes.

The turbo codes are known as parallel concatenated codes. The turbo codes invented by Berrou exhibit improved performance than those of the conventional coding and modulation scheme when a frame size is large. As the turbo codes have excellent performance in the iterative decoding, various codes for which the iterative decoding is possible are being studied and developed.

The turbo codes are combined in parallel on the basis of the interleaver, while the serially concatenated codes are serially combined on the basis of the interleaver. The serially concatenated codes can solve a problem in which the turbo codes have an error floor at a high SNR.

The LDPC codes have been developed in the form of block codes and are expressed as a matrix. The number of parity bits of 1's is a low density in the matrix. The iterative decoding is possible for the LDPC codes. The LDPC codes outperform the turbo codes.

As the BICM scheme mentioned above is a system in which iterative decoding is possible. The BICM scheme is a modulation scheme in which the convolutional codes are used on the basis of the interleaver and the bandwidth efficiency is greater than 1. For example, the BICM scheme is combined with 8PSK. The iterative decoding uses a soft decision value of a received frame and uses prior information when demodulation is performed according to a modulation constellation.

In the BICM scheme, the convolutional codes can be considered. Alternatively, such codes as the turbo codes, serially concatenated codes and LDPC codes described above can be considered in the BICM scheme when they are combined with a modulation scheme in which the bandwidth efficiency is good.

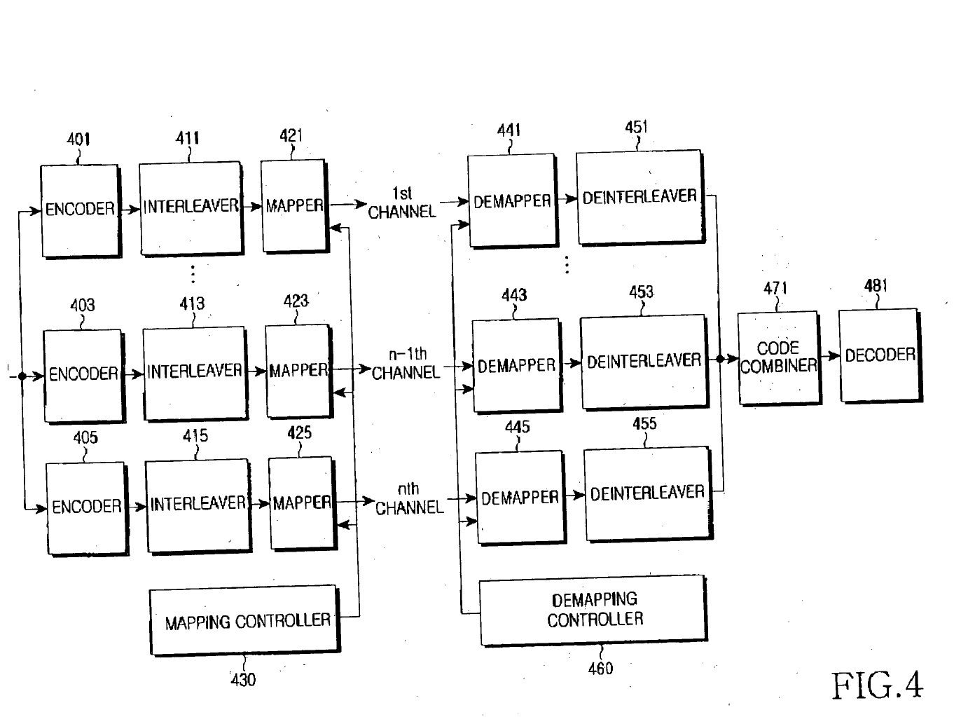

FIG. 4 is a schematic block diagram illustrating a wireless communication system requiring signal combining in accordance with an embodiment of the present invention.

Referring to FIG. 4, a transmitting side includes a plurality of encoders 401, 403 and 405, a plurality of interleavers 411, 413 and 415, a plurality of mappers 421, 423 and 425 and a mapping controller 430, and a receiving side includes a plurality of demappers 441, 443 and 445, a plurality of deinterleavers 451, 453 and 455, a demapping controller 460, a code combiner 471 and a decoder 481.

First, the operation of the transmitting side will be described.

Predetermined information bits to be transmitted are input to the encoders 401, 403 and 405 in a block unit. The encoders 401, 403 and 405 encode the input information bits according to a coding scheme based on system settings and outputs the encoded bits to the interleavers 411, 413 and 415. The interleavers 411, 413 and 415 interleave the input encoded bits and output the interleaved bits to the mappers 421, 423 and 425. The mappers 421, 423 and 425 convert the interleaved bits to baseband signals and output the baseband signals. At this time, the mapping controller 430 allocates a signal designation table according to a preset mapping method for the mappers 421, 423 and 425.

Signals output from the mappers 421, 423 and 425 are processed in a radio frequency (RF) processor (not illustrated) and are transmitted through channels. The signals transmitted through the channels are affected by additive white Gaussian noise (AWGN) due to fading or thermal noise in a mobile environment.

Next, the operation of the receiving side will be described.

Baseband signals transmitted through channels are input to the demappers 441, 443 and 445 associated with the channels, respectively. The demappers 441, 443 and 445 demap the baseband signals according to a demapping scheme associated with the mapping scheme applied in the transmitting side and output the demapped signals to the deinterleavers 451, 453 and 455. The demapping controller 460 performs a control operation such that a signal designation table is allocated for the demappers 441, 443 and 445 according to a preset demapping method and a demodulation process is performed.

The deinterleavers 451, 453 and 455 deinterleave the input demapped signals and output the deinterleaved signals to the code combiner 471. The code combiner 471 receives the deinterleaved signals from the deinterleavers 451, 453 and 455, code-combines the received signals and outputs the code-combined signals to the decoder 481. The decoder 481 receives the code-combined signals, decodes the received signals according to a decoding scheme associated with the coding scheme applied in the transmitting side and outputs the decoded signals. The signals output from the decoder 481 undergo a soft decision process in a bit unit. A result of the soft decision process, i.e., a soft decision value, is extracted, such that a decoded value is generated.

After input information bits are processed in a block unit, encoded and interleaved as described above, they are converted to baseband signals by the mappers. At this time, an independent coding process is performed according to a situation of HARQ, relay combining or macro diversity. Next, the coding process based on each situation will be briefly described.

The HARQ situation indicates retransmission of an independent channel. That is, a mapping scheme differs according to retransmission under control of the mapping controller 430.

When one relay and an uplink situation are considered in the relay combining, two signals including a signal transmitted from an MS to a BS and a signal transmitted from a relay to the BS are combined.

In the macro diversity situation, BSs independently perform coding processes.

In an embodiment of the present invention, the encoder and the interleaver can be individually and independently designed according to each situation. Control of the mapper will now be described.

The receiving side performs independent deinterleaving and demapping processes for signals received from independent channels, extracts a soft decision value and performs code combining. The decoder reproduces original information bits from combined signals.

It has been assumed that the sizes of sets of signals combined in the signal combining are identical. Alternatively, the sizes of the signal sets may differ from each other according to an application. That is, if the current channel situation is better or worse than the previous channel situation when a previously transmitted frame is retransmitted in the HARQ situation, signal order of the frame to be currently transmitted is increased or decreased accordingly, such that a more reliable communication scheme can be configured. This case can be formed also in a relay application. In the macro diversity situation, modulation order can be set according to a link state because a channel state of a link from the BS to the MS is different according to relative positions of BSs and MSs. This example will now be described.

For example, a search metric can be expressed as shown in Equation (5) when a 2^{q1}-ary modulation scheme and 2^{q2}-ary modulation scheme are combined.

$$D = \frac{1}{{q}_{1} {2}^{{q}_{1}} {q}_{2} {2}^{{q}_{2}}} {\sum }_{{i}_{1} = 1}^{{q}_{1}} {\sum }_{{b}_{1} = 0}^{1} {\sum }_{{S}_{{k}_{1}} ∈ {X}_{{b}_{1}}^{{i}_{1}}}^{} {\sum }_{{\hat{S}}_{{k}_{1}} ∈ X \frac{{i}_{1}}{{b}_{1}}}^{} {\sum }_{{i}_{2} = 1}^{{q}_{2}} {\sum }_{{b}_{2} = 0}^{1} {\sum }_{{S}_{{k}_{2}} {∈}_{{b}_{2}}^{{i}_{2}}}^{} {\sum }_{{\hat{S}}_{{k}_{2}} ∈ X \frac{{i}_{2}}{{b}_{2}}} M ( {S}_{{k}_{1}} , {\hat{S}}_{{k}_{1}} , {S}_{{k}_{2}} , {\hat{S}}_{{k}_{2}} ) \qquad Equation ( 5 )$$

In Equation (5), D denotes the search metric, and q₁ and q₂ , denote the number of bits according to a modulation scheme. Sₖ denotes a signal point belonging to a set X_{b}ⁱ and Ŝ^{k} denotes a signal point belonging to a set X_{\overline{bⁱ}. X}_{b}ⁱ denotes a signal set with the parameter b in the i-th bit position. i₁ and i₂ denote bit positions and b₁ and b₂ denote binary parameters. M(Sₖ_{₁},Ŝₖ_{₁}, Sₖ_{₂},Ŝₖ_{₂}) denotes a performance metric in the signal points belonging to the sets X_{b}ⁱ and X_{\overline{b}}ⁱ.

Here, M(Sₖ_{₁},Ŝₖ_{₁},Sₖ_{₂},Ŝₖ_{₂}) differs according to environment. For example, M(Sₖ_{₁},Ŝₖ_{₁},Sₖ_{₂}Ŝₖ_{₂}) in a fading channel can be expressed as shown in Equation (6) and M(Sₖ_{₁},Ŝₖ_{₁},Sₖ_{₁},Ŝₖ_{₂}) in an AWGN channel can be expressed as shown in Equation (7).

$$\begin{matrix}\{ \begin{matrix}M ( {S}_{{k}_{1}} , {\hat{S}}_{{k}_{1}} , {S}_{{k}_{2}} , {\hat{S}}_{{k}_{2}} ) = \frac{1}{{\vert {S}_{{k}_{1}} - {\hat{S}}_{{k}_{1}} \vert}^{2} \cdot {\vert {S}_{{k}_{2}} - {\hat{S}}_{{k}_{2}} \vert}^{2}} & ( {b}_{1} = {b}_{2} ) \\ M ( {S}_{{k}_{1}} , {\hat{S}}_{{k}_{1}} , {S}_{{k}_{2}} , {\hat{S}}_{{k}_{2}} ) = 0 & ( {b}_{1} \neq {b}_{2} )\end{matrix} & Equation ( 6 ) \\ \{ \begin{matrix}\begin{matrix}M ( {S}_{{k}_{1}} , {\hat{S}}_{{k}_{1}} , {S}_{{k}_{2}} , {\hat{S}}_{{k}_{2}} ) = exp ( - \frac{{E}_{s}}{4 {N}_{0}} {\vert {S}_{{k}_{1}} - {\hat{S}}_{{k}_{1}} \vert}^{2} ) \\ \cdot exp ( - \frac{{E}_{s}}{4 {N}_{0}} {\vert {S}_{{k}_{2}} - {\hat{S}}_{{k}_{2}} \vert}^{2} )\end{matrix} & ( {b}_{1} = {b}_{2} ) \\ M ( {S}_{{k}_{1}} , {\hat{S}}_{{k}_{1}} , {S}_{{k}_{2}} , {\hat{S}}_{{k}_{2}} ) = 0 & ( {b}_{1} \neq {b}_{2} )\end{matrix} & Equation ( 7 )\end{matrix}$$

As shown in Equations (6) and (7), a search metric computation is given by a multiple of a search metric for each modulation order.

The equation of the above-described search metric can differ according to system configuration conditions as well as channel environments. That is, the equation of the search metric is configured in the case of the combining of two signals, but can be extended to the combining of more than two signals. The combining of n signals can be expressed as shown in Equation (8).

$$D = \frac{1}{{q}_{1} {2}^{q1} {q}_{2} {2}^{q2} ⋯ {q}_{n} {2}^{qn}} {\sum }_{{i}_{1} = 1}^{q1} {\sum }_{{b}_{1} = 0}^{1} {\sum }_{{S}_{{k}_{1}} ∈ {X}_{{b}_{1}}^{{i}_{1}}}^{} {\sum }_{{\hat{S}}_{{k}_{1}} ∈ X \frac{{i}_{1}}{{b}_{1}}}^{} {\sum }_{{i}_{2} = 1}^{{q}_{2}} {\sum }_{{b}_{2} = 0}^{1} {\sum }_{{S}_{{k}_{2}} ∈ {X}_{{b}_{2}}^{{i}_{2}}}^{} {\sum }_{{\hat{S}}_{{k}_{2}} ∈ X \frac{{i}_{2}}{{b}_{2}}} \begin{matrix}⋯ {\sum }_{{i}_{n} = 1}^{{q}_{n}} {\sum }_{{b}_{n} = 0}^{1} {\sum }_{{S}_{{k}_{n}} ∈ {X}_{{b}_{n}}^{{i}_{n}}}^{} {\sum }_{{\hat{S}}_{{k}_{n}} ∈ X \frac{{i}_{n}}{{b}_{n}}} M\end{matrix} ( {S}_{{k}_{1}} , {\hat{S}}_{{k}_{1}} , {S}_{{k}_{2}} , {\hat{S}}_{{k}_{2}} ⋯ , {S}_{{k}_{n}} , {\hat{S}}_{{k}_{n}} ) \qquad Equation ( 8 )$$

In Equation (8), D denotes a search metric in the combining of ti signals, and q₁ and q₂ denote the number of bits according to a modulation scheme. Sₖ denotes a signal point belonging to a set X_{b}ⁱ and Ŝₖ denotes a signal point belonging to a set X_{\overline{b}}ⁱ. X_{b}ⁱ denotes a signal set with the parameter b in the i-th bit position. i₁ and i₂ denote bit positions and b₁ and b₂ denote binary parameters. M(Sₖ_{₁},Ŝₖ_{₁}, Sₖ_{₂},Ŝₖ_{₂} . . . ,Sₖ_{ₙ},Ŝₖ_{ₙ}) denotes a performance metric in the signal points belonging to the sets X_{b}ⁱ and X_{\overline{b}}ⁱ.

Here, M(Sₖ_{₁},Ŝₖ_{₁},Sₖ_{₂},Ŝₖ_{₂} . . . ,Sₖ_{ₙ}, Ŝₙ_{₂}) differs according to a given environment. For example, M (Sₖ_{₁},Ŝₖ_{₁},Sₖ_{₂},Ŝₖ_{₂} . . . , Sₖ_{ₙ},Ŝₖ_{ₙ}) in a fading channel can be expressed as shown in Equation (9) and M(Sₖ_{₁},Ŝₖ_{₁}, Sₖ_{₂},Ŝₖ_{₂} . . . ,Sₖ_{ₙ},Ŝₖ_{ₙ}) in an AWGN channel can be expressed as shown in Equation (10).

$$\begin{matrix}\{ \begin{matrix}\begin{matrix}M ( {S}_{{k}_{1}} , {\hat{S}}_{{k}_{1}} , {S}_{{k}_{2}} , {\hat{S}}_{{k}_{2}} ⋯ , {S}_{{k}_{n}} , {\hat{S}}_{{k}_{n}} ) = \frac{1}{{\vert {S}_{{k}_{1}} - {\hat{S}}_{{k}_{1}} \vert}^{2}} \cdot \frac{1}{{\vert {S}_{{k}_{2}} - {\hat{S}}_{{k}_{2}} \vert}^{2}} \\ \cdot … \cdot \frac{1}{{\vert {S}_{{k}_{n}} - {\hat{S}}_{{k}_{n}} \vert}^{2}}\end{matrix} & \begin{matrix} \\ ( where {b}_{1} = {b}_{2} = … = {b}_{n} )\end{matrix} \\ M ( {S}_{{k}_{1}} , {\hat{S}}_{{k}_{1}} , {S}_{{k}_{2}} , {\hat{S}}_{{k}_{2}} ⋯ , {S}_{{k}_{n}} , {\hat{S}}_{{k}_{n}} ) = 0 & \begin{matrix}( where at least one of \\ {b}_{1} , {b}_{2} , … , {b}_{n} is different )\end{matrix}\end{matrix} & Equation ( 9 ) \\ \{ \begin{matrix}\begin{matrix}M ( {S}_{{k}_{1}} , {\hat{S}}_{{k}_{1}} , {S}_{{k}_{2}} , {\hat{S}}_{{k}_{2}} ⋯ , {S}_{{k}_{n}} , {\hat{S}}_{{k}_{n}} ) = exp ( - \frac{{E}_{s}}{4 {N}_{0}} {\vert {S}_{{k}_{1}} - {\hat{S}}_{{k}_{1}} \vert}^{2} ) \\ \cdot exp ( - \frac{{E}_{s}}{4 {N}_{0}} {\vert {S}_{{k}_{2}} - {\hat{S}}_{{k}_{2}} \vert}^{2} ) \\ \cdot … \cdot exp ( - \frac{{E}_{s}}{4 {N}_{0}} {\vert {S}_{{k}_{n}} - {\hat{S}}_{{k}_{n}} \vert}^{2} )\end{matrix} & ( where {b}_{1} = {b}_{2} = … = {b}_{n} ) \\ M ( {S}_{{k}_{1}} , {\hat{S}}_{{k}_{1}} , {S}_{{k}_{2}} , {\hat{S}}_{{k}_{2}} ⋯ , {S}_{{k}_{n}} , {\hat{S}}_{{k}_{n}} ) = 0 & \begin{matrix}( where at least one of \\ {b}_{1} , {b}_{2} , … , {b}_{n} is different )\end{matrix}\end{matrix} & Equation ( 10 )\end{matrix}$$

When the search metric is extended, a size of the signal set for obtaining a sum can be determined according to the presence of prior information.

In a concept of the number of error events, the search metric is extended as shown in Equations (11) and (12).

$$\{ \begin{matrix}\begin{matrix}{N}_{min} ( 1 ) = \frac{1}{{q}_{1} {2}^{q1} {q}_{2} {2}^{q2 } ⋯ {q}_{n} {2}^{qn} } \\ {\sum }_{{i}_{1} = 1}^{q1} {\sum }_{{b}_{1} = 0}^{1} {\sum }_{{S}_{{k}_{1}} ∈ {X}_{{b}_{1}}^{{i}_{1}}}^{} {\sum }_{{i}_{2} = 1}^{{q}_{2}} {\sum }_{{b}_{2} = 0}^{1} {\sum }_{{S}_{{k}_{2}} ∈ {X}_{{b}_{2}}^{{i}_{2}}}^{} \\ ⋯ {\sum }_{{i}_{n} = 1}^{{q}_{n}} {\sum }_{{b}_{n} = 0}^{1} {\sum }_{{S}_{{k}_{n}} ∈ {X}_{{b}_{n}}^{{i}_{n}}}^{} {N}_{min} ( 1 , {S}_{{k}_{1}} , {S}_{{k}_{2}} , ⋯ , {S}_{{k}_{n}} )\end{matrix} & ( where {b}_{1} = {b}_{2} = … = {b}_{n} ) \\ {N}_{min} ( 1 ) = 0 & \begin{matrix}( where at least one of \\ {b}_{1} , {b}_{2} , … , {b}_{n} is different )\end{matrix}\end{matrix} \qquad Equation ( 11 )$$

In Equation (11), Nₘᵢₙ denotes the minimum number of neighbor signal points in which an error may occur in a symbol unit. Nₘᵢₙ(1,Sₖ_{₁}, Sₖ_{₂}, . . . ,Sₖ_{ₙ}) denotes the average number of neighbor signal points in which an error occurs in a bit unit.

$${N}_{b} = {\sum }_{{i}_{1} = 0}^{{2}^{q 1} - 1} {\sum }_{{i}_{2} = 0}^{{2}^{q 2} - 1} … {\sum }_{{i}_{n} = 0}^{{2}^{qn} - 1} p ( {i}_{1} , … , {i}_{n} ) {\sum }_{{j}_{1} = 1}^{{N}_{{i}_{1}}} {\sum }_{{j}_{2} = 1}^{{N}_{{i}_{2}}} … {\sum }_{{j}_{n} = 1}^{{N}_{{i}_{n}}} {n}_{b} ( {i}_{1} , {i}_{2} , … , {i}_{n} , {j}_{1} , {j}_{2} , … , {j}_{n} ) \qquad Equation ( 12 )$$

In Equation (12), N_{b} denotes the number of neighbor signal points in which an error may occur in a symbol unit. p(i₁,i₂, . . . ,iₙ.) denotes a probability of selection of an arbitrary i signal point. n_{b}(i₁i₂, . . . iₙ,j₁,j₂, . . . ,jₙ) denotes the number of error bits when i signal points are erroneously determined to be j signal points.

Now, a process for performing a search using the above-described search metrics will be described with reference to the accompanying drawing.

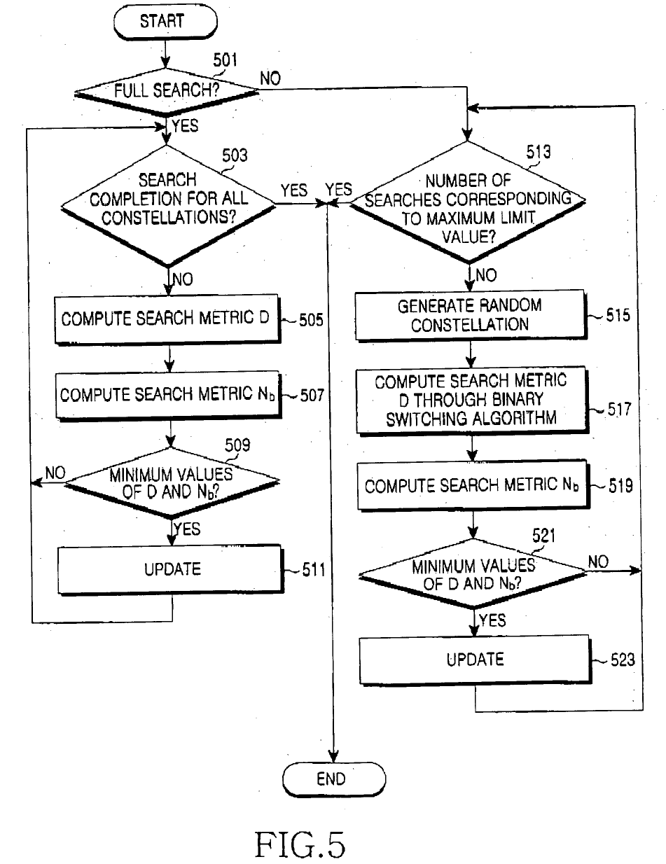

FIG. 5 is a flowchart illustrating a search process using a search metric in accordance with an embodiment of the present invention.

Referring to FIG. 5, a determination is made as to whether a full search is possible in step 501. If the fill search is possible as a result of the determination, the process proceeds to step 503. However, if the full search is not possible as a result of the determination, the process proceeds to step 513.

If the full search is possible in step 503, a determination is made as to whether the search has been completed for all possible constellation combinations. If the search has been completed for all the constellation combinations as a result of the determination, the process ends. However, if the search has not been completed for all the constellation combinations as a result of the determination, the process proceeds to step 505. A search metric D at a relatively high SNR is computed in step 505, and the process proceeds to step 507. A search metric N_{b} at a relatively low SNR is computed in step 507, and the process proceeds to step 509.

In step 509, a determination is made as to whether the search metrics D and N_{b} computed in steps 505 and 507 have minimum values. If the computed search metric values are not minimum values as a result of the determination, the process proceeds to step 503 to be repeated. However, if the computed search metric values are minimum values as a result of the determination, the process proceeds to step 511. A constellation is updated by the minimum values in step 511. Then, the process is performed for the next constellation combination in step 503.

If the full search is impossible as a result of the determination in step 501, a determination is made as to whether searches corresponding to a maximum limit value have been performed for an irregular constellation in step 513. If the searches corresponding to the maximum limit value have been performed, the process ends. However, if the number of searches is less than the maximum limit value, the process proceeds to step 515. A random constellation is generated in step 515 and then the process proceeds to step 517.

A search metric D at a relatively high SNR is computed through a binary switching algorithm for the generated random constellation in step 517, and the process proceeds to step 519. In this case, the binary switching algorithm continuously switches between two points on a given random constellation until the search metric D is minimized. When the search metric value is no longer varied, the binary switching algorithm ends. A search metric N_{b} at a relatively low SNR is computed in step 519, and the process proceeds to step 521.

In step 521, a determination is made as to whether the search metrics D and N_{b} computed in steps 517 and 519 have minimum values. If the computed search metric values are not minimum values as a result of the determination, the process proceeds to step 513 to be repeated. However, if the computed search metric values are minimum values as a result of the determination, the process proceeds to step 523. A constellation is updated by the minimum values in step 523. Then, the process is performed for the next constellation combination in step 513.

As illustrated in FIG. 5, search methods using search metrics are divided into a full search and a partial search. The search metric D indicates a final performance at a relatively high SNR, and the search metric N_{b} determines a performance at a relatively low SNR. In this case, the performance is optimal when the N_{b} value is small even when the search metric D is identical. Therefore, a constellation with the minimum D value is searched on the basis of a primary search criterion and a constellation with the small N_{b} value is searched on the basis of a secondary search criterion when the D value is identical.

When the full search is possible, search metrics D and N_{b} are computed for all possible constellation combinations, and a constellation with minimum values is obtained. In the process for obtaining the minimum values as described above, a value of the search metric D is the primary selection criterion and a value of the search metric N_{b} is the secondary selection criterion when the value of the search metric D is identical.

When the full search is not possible, irregular constellations corresponding to a predetermined limit value are generated and a search metric is searched. At this time, the binary switching algorithm is performed such that a mapped value is switched within the generated irregular constellations corresponding to the predetermined limit value, and the value of the search metric D is continuously reduced. Subsequently, the search metric N_{b} is computed as in the full search when the search metric D is no longer reduced through the binary switching algorithm. Values of the computed search metrics are then compared with the minimum values. Here, a comparison priority is the same as that of the full search. The above-described process is repeated a number of times.

The process in which signal combining is considered has been described. The present invention can also be applied to a process in which signal combining is not considered. The process based on the signal combining is different from other processes because a process for multiple constellation combinations is performed.

As described above, the present invention proposes a search metric for obtaining an optimal mapping method in a communication system such as a hybrid automatic retransmission request (HARQ) communication system, a communication using a relay or a macro diversity communication system requiring a decoding process through signal combining, and a search method using the search metric. The present invention can provide higher link level performance in various systems through a mapping method using the search method and can increase system throughput.

As described above, the present invention proposes a mapping method for signal combining in a wireless communication system and more particularly an optimal mapping method for use in variously applied signal combining situations in a digital communication system, thereby implementing improved performance as compared with that of the conventional communication system using signal combining. The present invention can extend a conventional search metric and can be applied to a system requiring signal combining. The present invention can provide an optimal mapping method that can improve performance through signal combining when a channel coding scheme in which different modulation schemes are mutually combined is considered in a plurality of communication systems. The present invention can improve higher link level performance and system throughput in various digital communication systems.

Although preferred embodiments of the present invention have been disclosed for illustrative purposes, those skilled in the art will appreciate that various modifications, additions, and substitutions are possible, without departing from the scope of the present invention. Therefore, the present invention is not limited to the above-described embodiments, but is defined by the following claims, along with their full scope of equivalents.

What is claimed is:

1. A mapping method for signal combining in a wireless communication system, comprising the steps of:
determining whether a full search is possible for an arbitrary mapping table;
computing search metric values for all possible constellation combinations when the full search is possible and producing a constellation with a minimum value using the computed search metric values; and
continuously reducing a search metric value within an irregular constellation when the full search is not possible, obtaining the reduced search metric value corresponding to a minimum value and producing a constellation with a minimum value using the obtained reduced search metric value.

2. The mapping method of claim 1, further comprising the step of:
comparing the computed search metric values with a minimum threshold to produce the constellation.

3. The mapping method of claim 1, further comprising the steps of:
generating irregular constellations corresponding to a limit value if the full search is not possible; and
performing a binary switching process for switching a mapped value within the generated irregular constellations and continuously reducing the search metric value.

4. The mapping method of claim 1, wherein the search metric is based on a system configuration and is expressed by:
$$D = \frac{1}{{q}_{1} {2}^{q 1} {q}_{2} {2}^{q 2} … {q}_{n} {2}^{qn}} {\sum }_{{i}_{1} = 1}^{q 1} {\sum }_{{b}_{1} = n}^{1} {\sum }_{{S}_{{k}_{1}} ∈ {X}_{{b}_{1}}^{{i}_{1}}}^{} {\sum }_{ {\overline{S}}_{{k}_{1}} ∈ {X}_{{b}_{1}}^{{i}_{2}}}^{} {\sum }_{{i}_{2} = 1}^{q 2} {\sum }_{{b}_{2} = 1}^{1} {\sum }_{{S}_{{k}_{2}} ∈ {X}_{{b}_{2}}^{{i}_{2}}}^{} {\sum }_{ {\overline{S}}_{{k}_{2}} ∈ {X}_{{b}_{2}}^{{i}_{2}}}^{} … {\sum }_{{i}_{n} = 1}^{{q}_{n}} {\sum }_{{b}_{n} = n}^{1} {\sum }_{{S}_{{k}_{n}} ∈ {X}_{ {\overline{b}}_{n}}^{{i}_{n}}}^{} {\sum }_{ {\overline{S}}_{{k}_{n}} ∈ {X}_{ {\overline{b}}_{n}}^{{i}_{n}}}^{} M ( {S}_{{k}_{1}} , {\hat{S}}_{{k}_{1}} , {S}_{{k}_{2}} , \hat{{S}_{{k}_{2}} } … , {S}_{{k}_{n}} , {\hat{S}}_{{k}_{n}} ) ,$$
where D denotes a search metric in combining of n signals, q₁ and q₂ denote the number of bits according to a modulation scheme, Sₖ denotes a signal point belonging to a set X_{b}ⁱ, Ŝₖ denotes a signal point belonging to a set X_{\overline{b}}ⁱ, X_{b}ⁱ denotes a signal set with a parameter b in an i-th bit position, i₁ and i₂ denote bit positions, b₁ and b₂ denote binary parameters and M(Sₖ_{₁},Ŝₖ_{₁},Sₗ_{₂},Ŝₖ_{₂}, . . . ,Sₖ_{ₙ},Ŝₖ_{ₙ}) denotes a performance metric in the signal points belonging to the sets X_{b}ⁱ and X_{\overline{b}}ⁱ.

5. The mapping method of claim 4, wherein M(Sₖ_{₁},Ŝₖ_{₁},Sₖ_{₂},Ŝₖ_{₂} . . . ,Sₖ_{ₙ},Ŝₖ_{₂}) in a fading channel is defined by:
$$\{ \begin{matrix}\begin{matrix}M ( {S}_{{k}_{1}} , {\hat{S}}_{{k}_{1}} , {S}_{{k}_{2}} {\hat{S}}_{{k}_{2}} … , {S}_{{k}_{n}} , {\hat{S}}_{{k}_{n}} ) = \\ \frac{1}{{\vert {S}_{{k}_{1}} - {\hat{S}}_{{k}_{1}} \vert}^{2}} \cdot \frac{1}{{\vert {S}_{{k}_{2}} - {\hat{S}}_{{k}_{2}} \vert}^{2}} \cdot … \cdot \frac{1}{{\vert {S}_{{k}_{n}} - {\hat{S}}_{{k}_{n}} \vert}^{2}}\end{matrix} & ( where {b}_{1} = {b}_{2} = … = {b}_{n} ) \\ M ( {S}_{{k}_{1}} , {\hat{S}}_{{k}_{1}} , {S}_{{k}_{2}} {\hat{S}}_{{k}_{2}} … , {S}_{{k}_{n}} , {\hat{S}}_{{k}_{n}} ) = 0 & \begin{matrix}( where at least one of {b}_{1} , {b}_{2} , … , {b}_{n} \\ is a different value than remaining values in \\ {b}_{1} , {b}_{2} , … , {b}_{n} )\end{matrix}\end{matrix}$$

6. The mapping method of claim 4, wherein M(Sₖ_{₁},Ŝₖ_{₂},Sₖ_{₂},Ŝₖ_{₂}, . . . ,Sₖ_{ₙ},Ŝₖ_{ₙ}) in an additive white Gaussian Noise (AWGN) channel is defined by:
$$\{ \begin{matrix}\begin{matrix}M ( {S}_{{k}_{1}} , {\hat{S}}_{{k}_{1}} , {S}_{{k}_{2}} {\hat{S}}_{{k}_{2}} … , {S}_{{k}_{n}} , {\hat{S}}_{{k}_{n}} ) = \\ exp ( - \frac{{E}_{s}}{4 {N}_{0}} {\vert {S}_{{k}_{1}} - {\hat{S}}_{{k}_{1}} \vert}^{2} ) \cdot exp ( - \frac{{E}_{s}}{4 {N}_{0}} {\vert {S}_{{k}_{2}} - {\hat{S}}_{{k}_{2}} \vert}^{2} ) \cdot \\ … \cdot exp ( - \frac{{E}_{s}}{4 {N}_{0}} {\vert {S}_{{k}_{n}} - {\hat{S}}_{{k}_{n}} \vert}^{2} )\end{matrix} & ( where {b}_{1} = {b}_{2} = … = {b}_{n} ) \\ M ( {S}_{{k}_{1}} , {\hat{S}}_{{k}_{1}} , {S}_{{k}_{2}} , {\hat{S}}_{{k}_{2}} … , {S}_{{k}_{n}} , {\hat{S}}_{{k}_{n}} ) = 0 & \begin{matrix}( where at least one of {b}_{1} , {b}_{2} , … , {b}_{n} \\ is a different value than remaining values in \\ {b}_{1} , {b}_{2} , … , {b}_{n} )\end{matrix}\end{matrix}$$

7. The mapping method of claim 1, wherein the search metric is based on a number of error events and is expressed by:
$$\{ \begin{matrix}\begin{matrix}{N}_{min} ( 1 ) = \frac{1}{{q}_{1} {2}^{{q}_{1}} {q}_{2} {2}^{{q}_{2}} … {q}_{n} {2}^{{q}_{n}}} \\ {\sum }_{{i}_{1} = 1}^{q 1} {\sum }_{{b}_{1} = 0}^{1} {\sum }_{{S}_{{k}_{1}} ∈ {X}_{{b}_{1}}^{{i}_{1}}}^{} {\sum }_{{i}_{2} = 1}^{{q}_{2}} {\sum }_{{b}_{2} = 0}^{1} {\sum }_{{S}_{{k}_{2}} ∈ {X}_{{b}_{2}}^{{i}_{2}}}^{} … {\sum }_{{i}_{n} = 1}^{{q}_{n}} {\sum }_{{b}_{n} = 0}^{1} {\sum }_{{S}_{{k}_{n}} ∈ {X}_{{b}_{n}}^{{i}_{n}}}^{} \\ {N}_{min} ( 1 , {S}_{{k}_{1}} , {S}_{{k}_{2}} , … , {S}_{{k}_{n}} )\end{matrix} & ( where {b}_{1} = {b}_{2} = … = {b}_{n} ) \\ {N}_{min} ( 1 ) = 0 & \begin{matrix}( where at least one of {b}_{1} , {b}_{2} , … , {b}_{n} \\ is a different value than remaining values in \\ {b}_{1} , {b}_{2} , … , {b}_{n} )\end{matrix}\end{matrix}$$
where Nₘᵢₙ denotes a minimum number of neighbor signal points in which an error may occur in a symbol unit and Nₘᵢₙ(1,Sₖ_{₁},Sₖ_{₂}, . . . ,Sₖ_{ₙ}) denotes an average number of neighbor signal points in which an error occurs in a bit unit.

8. The mapping method of claim 1, wherein the search metric is based on a number of error events and is expressed by:
$${N}_{b} = {\sum }_{{i}_{1} = 0}^{{2}^{q 1} - 1} {\sum }_{{i}_{2} = 0}^{{2}^{q 2} - 1} … {\sum }_{{i}_{n} = 0}^{{2}^{qn} - 1} p ( {i}_{1} , {i}_{2} , … , {i}_{n} ) {\sum }_{{j}_{1} = 1}^{{N}_{{i}_{1}}} {\sum }_{{j}_{2} = 1}^{{N}_{{i}_{2}}} … {\sum }_{{j}_{n} = 1}^{{N}_{{i}_{n}}} {n}_{b} ( {i}_{1} , {i}_{2} , … , {i}_{n} , {j}_{1} , {j}_{2} , … , {j}_{n} ) ,$$
where N_{b} denotes a number of neighbor signal points in which an error may occur in a symbol unit, p(i₁,i₂, . . . , iₙ) denotes a probability of selection of an arbitrary i signal point and n_{b}(i₁,i₂, . . . ,iₙ,j₁,j₂, . . . ,jₙ) denotes a number of error bits when i signal points are erroneously determined to be j signal points.

9. The mapping method of claim 1, further comprising the steps of:
computing a first search metric value at a high signal-to-noise ratio (SNR) if the full search is possible for the arbitrary mapping table;
computing a second search metric value at a low SNR after the first search metric value is computed;
comparing the computed first and second search metric values with threshold values;
selecting minimum values of the first and second search metric values according to a comparison result; and
updating a constellation using the selected minimum values.

10. The mapping method of claim 9, wherein a constellation in which the second search metric value is low is selected when the first search metric value of the constellation combinations is identical.

11. The mapping method of claim 1, further comprising the steps of:
generating a random constellation if the full search is not possible for the arbitrary mapping table;
computing a first search metric value at a high signal-to-noise ratio (SNR) in the generated random constellation;
computing a second search metric value at a low SNR after the first search metric value is computed;
comparing the computed first and second search metric values with threshold values;
selecting minimum values of the first and second search metric values according to a comparison result; and
updating a constellation using the selected minimum values.

12. The mapping method of claim 11, wherein the first search metric value is computed for the random constellation through a binary switching algorithm.

13. The mapping method of claim 12, wherein the binary switching algorithm continuously switches between two points on the random constellation until the first search metric value is minimized in the constellation and obtains the minimum value of the first search metric value.

14. The mapping method of claim 11, wherein a constellation in which the second search metric value is low is selected when the first search metric value is identical in the generated random constellation.

15. A mapping method using a search metric in a digital communication system requiring signal combining, comprising the steps of:
computing a first search metric value at a high signal-to-noise ratio (SNR) and a second search metric value at a low SNR when a full search is possible for an arbitrary mapping table;
updating a constellation using minimum values of the computed first and second search metric values;
generating a random constellation when a number of searches for an irregular constellation does not exceed a maximum value when the full search is not possible for the arbitrary mapping table;
computing first and second search metric values for the generated random constellation through a binary switching algorithm; and
updating a constellation using minimum values of the computed first and second search metric values.

16. The mapping method of claim 15, wherein a constellation in which the second search metric value is low is selected when the first search metric value is identical between combinations of constellation.

17. The mapping method of claim 15, wherein the binary switching algorithm continuously switches between two points on a given random constellation until the first search metric value is minimized in the constellation and obtains the minimum value of the first search metric value.

18. The mapping method of claim 15, wherein a constellation in which the second search metric value is low is selected when the first search metric value is identical in the generated random constellation.
